(19) United States
(12) Patent Application Publication
(10) Pub. No.: US 2005/0203785 A1
(43) Pub. Date: Sep. 15, 2005

(54) Automated dispute settlement method

(76) Inventor: Robert V. Kixmiller, Carmel, IN (US)

Correspondence Address: MAGINOT, MOORE & BECK;BANK ONE CENTER/TOWER, 1111 MONUMENT CIRCLE, INDIANAPOLIS, IN, 46204, US

(21) Appl. No.: 10/797,517

(22) Filed: Mar. 10, 2004

(51) Int. Cl. G06F 17/60

(52) U.S. Cl. 705/7

(57) ABSTRACT

A web-based automated settlement system and method provides on-line access to a settlement system that maintains the offers of the parties confidential unless and until certain negotiation conditions arise. A first party registers the dispute on the web-site and enters information concerning the parties and the dispute, including the e-mail addresses of the parties. The first party can elect a split and settle option in which the underlying software automatically calculates a mid-point dollar amount between two non-confidential offers made by the parties prior to registering the dispute. Settlement is reached if the other party also selects the split and settle option. Alternatively, the first party enters a dollar amount offer and a proximity test value. The underlying software calculates a disclosure dollar amount based on the offer and the proximity test value. If the other party tenders a counter-offer within the disclosure dollar amount, the parties are notified by e-mail of the offer and counter-offer. A contract executed by the parties upon registration of the dispute makes the disclosed offer and counter-offer binding on the respective party. The offers are maintained confidential unless and until the negotiation condition is met.

The present invention relates generally to systems and methods for automating the settlement of monetary disputes between parties. More particularly, the invention concerns an automated dispute settlement method that is implemented through the Internet and e-mail communications media.

Disputes are a virtual certainty in any society. A great percentage of these disputes revolve around money—how much is owed to whom. A vast legal system has been built around resolving monetary disputes, whether it involves a dispute over money owed or a cause of action for damages arising from a commercial or physical injury to a party. Even in a litigious society, most disputes do settle without resort to the courts.

However, even the settlement process is fraught with peril and uncertainty. Many disputes settle late in the game, often on the courthouse steps and usually only in an effort to avoid an uncertain outcome in litigation. Of course, by that time, all litigants have spent a significant amount of money in prosecuting or defending the lawsuit. While the courthouse settlement is a meaningful and preferable alternative to a trial, such a settlement would be less costly and probably more fair if it had occurred much earlier in the process.

One of the settlement dynamics that impedes the early resolution of many disputes is that the parties find it very difficult to move very far or very fast in their negotiations. Impediments to prompt settlement include posturing, a fear of appearing weak or uncertain, an unrealistic vision or understanding of the other side's position, or fear of vulnerability. In most cases, the negotiation starts at extreme positions and passes through a number of incremental, snail-like movements before a final settlement number is reached. Removing these impediments can help the parties achieve agreement much more quickly.

Mediators can play a vital role in advancing settlement. The mediator can frequently speed the process by finding out from each party, on a confidential basis, what are that party's “trigger points”—what does that party expect to get out of the dispute. In addition, the mediator can learn, or at least discern, a party's “bottom line”. During this information gathering, the mediator may discover that the “bottom lines” are not that far apart. If the parties are far apart at first, skillful wrangling by the mediator can frequently bring the parties within reach of each other. At that point, the parties are much closer together than they would have been had they set out on the traditional negotiation path.

One significant benefit of the mediator is that each party's conversations and disclosures are maintained in confidence until agreement is close at hand. All of the fears normally associated with face-to-face negotiations dissolve. There is no need for a party to avoid making a big move toward the middle, which carries the risk in personal negotiations of appearing uninformed, weak or desperate. Neither party holds back information or bargaining proposals because the filter of the mediator is always there. Moreover, either party can retrench and retract a previous settlement position while preserving the settlement opportunity.

While a mediator is a very valuable asset, not every dispute warrants mediation and not every party to a dispute wants to use a mediator. Most disputes are settled through person-to-person discussions, and most frequently through attorneys. Face-to-face settlement conferences can require significant commitment of time and monetary resources by the parties and their attorneys. Negotiations through mail, or even e-mail, can be slow and ripe for posturing. Both approaches eliminate the safe harbor of confidentiality that allows the participants to freely examine, offer and counter-offer without fear of reprisal or without risk of killing the negotiations.

In recent years, internet-based systems have arisen that guide parties through a settlement process. In many of these online settlement systems, each party is entitled to make a limited number of offers/counter-offers, usually three, in alternating fashion. The offers or bids are kept secret. If the two offers are within a predetermined range, as calculated by the online system, then many systems “split the difference” and inform the parties of their settlement amount.

A detriment of these prior systems is that they force the settlement amount to be at the midpoint between offers. This approach limits the flexibility of the settlement system and obligates the participants to “settle in the blind” at an unknown amount. Moreover, these prior systems only offer one approach to settlement, again limiting the flexibility of the system to meet differing expectations of the participants. There remains a need for an automated dispute settlement system that retains the security of confidentiality while providing flexible approaches to meet the desires of the participants.

### SUMMARY OF THE INVENTION

The present invention addresses the above drawbacks, as well as other needs, by providing a settlement system that has one or more of the features described herein. In one embodiment of the invention the settlement system generally comprises: (1) an Internet website that can be accessed by the parties to the settlement negotiations; (2) related computer software that stores and processes the data input via the website and makes the settlement system perform its intended functions; and (3) a contractual arrangement between two parties to a dispute or negotiation involving the amount of money to be paid by one party (the defendant) to the other party (the plaintiff or claimant). The settlement system: (a) receives and stores confidential proposed settlement offers (in dollar amounts) entered electronically at the website; (b) issues specific notifications to the two parties by email, with the type of notification dependent upon a comparison of the offers by both parties and a determination as to whether they fall within certain preselected criteria; and (c) if the disclosure of the cash settlement offers made by the parties is called for under the applicable criteria, makes the proposed offers of the two parties firm and binding settlement offers that cannot be withdrawn or changed for a specified period or until a party's proposed offer is rejected by the other party, depending upon certain criteria managed by the settlement system.

In one preferred embodiment, the invention contemplates that a first party (the offeror) registers the settlement case on the website and accepts the binding contract regarding the settlement outcome using the automated settlement website. It should be understood that the first party to register the settlement case can be the payor (i.e., the person owed money) or the payee (i.e., the person who must pay the money). While the overall automated settlement protocol is unchanged by the status of the initiating party, certain nuances arise during the process based on whether the initial offeror is a payor or a payee.

At the time of registration on the website, the offeror is directed first to a screen where the offeror can elect to use a “split and settle” option. A party may select this option when the parties have each made a settlement offer in traditional settlement negotiations. In one embodiment of the “split and settle” option, the registering party enters the last non-confidential pair of offers into the system. The offer in this embodiment that is processed by the system is an offer to split the difference. If the other party accepts this offer, the dispute is settled immediately at the midpoint between the non-confidential offers made by the parties prior to registering with this system.

In another embodiment of the “split and settle” system, the offeror is agreeing to allow the underlying software to calculate the midpoint between the original offer and the offeree's response. With this embodiment, if the offeree also agrees to “split and settle”, then the underlying software will calculate the midpoint between the parties' confidential offers.

Whether or not the offeror elects the “split and settle” option, the website next moves to the confidential offer screen where the offeror can submit a dollar offer for settlement. If an actual offer was made by the registering party (the offeror), the software supporting the website then transmits an e-mail to the other party informing that party that an opening offer has been made. The e-mail then directs the offeree to the automated settlement website. The offeree enters the website and is presented with the same binding contract that had been executed by the offeror to commence the automated settlement process. Once the offeree accepts the contract, the website directs him/her to the “split and settle screen” where he/she has the option to “split and settle” based on the latest offers made during the preceding traditional negotiations. It can be noted that the “split and settle” option is presented to the offeree, regardless of whether the offeror accepted or declined this settlement option. This presentation preserves the confidentiality of the offeror's initial offer and does not provide the responding party with any more information than the offeror wishes to settle the controversy and has made an initial offer to do so. The offeree can, of course, accept or reject the invitation to “split and settle” option.

If both the offeror and the offeree agree to “split and settle” between the latest non-confidential offers, the dispute is settled at the midpoint between the offers. The system informs the parties of this settlement by e-mail. If either of the parties refuses the “split and settle” option, the offeree is directed to a confidential settlement screen where the offeree is given the opportunity to make his/her own offer. This step of the process is independent of whether the offeror also made a dollar offer in addition to the originating offer to “split and settle”. This feature preserves the confidentiality of the offeror's conduct since there is nothing from which the offeree can determine in what form the original offer from the offeror came.

If the offeree makes a cash offer and if the offeror also made a cash settlement offer, the system compares the two offers and calculates the difference between them, in one embodiment of the invention. If the result of subtracting the payor's offer from the payee's offer is zero or a positive number, and if it is equal to or less than a pre-selected dollar amount (a “Disclosure Difference Amount” entered into the system by the offeror when the case was registered) then the two offers are disclosed by e-mail to the parties. Pursuant to the contract executed by the parties using the automated settlement system, each offer is binding on the respective offering party and cannot be withdrawn. Either binding offer may be accepted by the other party within a fixed period of time to complete the settlement. Alternatively, each party can reject the binding offer of the other party, at which point the automated settlement process is terminated.

If the two offers are farther apart than the Disclosure Difference Amount (DDA), or if either party has not made a cash settlement offer, the system automatically advises the parties by e-mail that no settlement has been reached. The offer activity of each party is kept confidential and is not disclosed.

In one aspect of this embodiment, if the offer of the payor (defendant) exceeds the demand of the payee (plaintiff), the offers are disclosed but are not binding offers. However, either party has the option to elect, within a set period of time, to effect settlement at the mid-point between the offers. An election so made is binding on both parties and forces a settlement at the mid-point.

It will be appreciated that the settlement system includes several unique features which do not necessarily need to be combined to provide at least some advantages over the prior art systems. Moreover, it will be appreciated that the settlement system described herein is merely an exemplary embodiment of the present invention(s).

### BRIEF DESCRIPTION OF THE DRAWINGS

FIG. 1 is a flow diagram of the operations of one embodiment of an automated settlement system executed by the initial party registering the dispute for resolution with this system.

FIG. 2 is a block diagram of the operations of the one embodiment of an automated settlement system executed by a party responding to the registration of the dispute for resolution using the system of the present invention.

### DESCRIPTION OF THE PREFERRED EMBODIMENTS

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

As discussed above, most disputes or negotiations involving claims for money damages are ultimately resolved by settlement at a mutually agreed settlement amount rather than by a trial or other proceeding. However, in many cases the settlement does not occur until after a considerable amount of time has passed and a considerable amount of money has been spent preparing for a trial or other proceeding that will never be held. Where one of the parties is a business concern, such as an insurance company, this unnecessary cost incurred is passed on to consumers in the form of increased cost of goods and services. On the other side of the coin, plaintiffs who have suffered personal or economic injury may be deprived of desperately needed funds for an extended period of time. Resolving claims by settlement sooner, and at less expense, would be of benefit to everybody involved.

The dynamics of the settlement negotiation process frequently involve two parties that each start out at rather extreme positions, as far as their settlement offers are concerned, and that thereafter move incrementally toward each other's position, through offers and counteroffers, until a mutually agreeable settlement amount is reached. A number of fears and concerns impact the negotiating strategies of the parties and may impede the ability of the parties to reach agreement on the ultimate settlement amount in an efficient and expeditious manner. The use of the present settlement system will eliminate or lessen the deterrent effect of those impediments to arriving at an agreed settlement as efficiently as possible, thereby enabling the parties to achieve a settlement sooner than they might otherwise be able to do without the use of the settlement system.

The settlement system operates on an assumption that at some point during the negotiation process, a party would be willing to settle for an amount that is substantially closer to the offer amount of the other party, but for some reason is reluctant to communicate that willingness to the opposing party. This reluctance may be attributable to any one or more of a number of fears and concerns common to most negotiations. For instance, a party may fear that a substantial move toward the middle might not be met with an equally substantial move toward the middle by the other party. Of course, if a party makes a unilateral move toward the middle, the midpoint between the offers changes in favor of the other non-reciprocating party.

A party may be reluctant to substantially change its offer position for fear that a substantial move will be perceived by the opposing party as a sign of weakness, thereby encouraging the opposing party to take a tougher stance in the negotiation process going forward. Another concern is that an offer, once made, cannot be effectively withdrawn because the opposing party will always know that such amount had been offered and will assume, going forward, that such amount will always be available from the party who made the offer.

A second assumption is that at some point during the negotiation process, both parties would be willing to split the difference between their latest offers and settle at that midpoint, but for some reason the parties are hesitant to make that fact known. The same fears that give rise to a party's reluctance to make a substantial move in its offer position are also at work in this scenario.

The settlement system of the present invention deals with these concerns by eliminating the feared results of a party making a substantial move in its offer position and ending up in a worse position than it had been in before making the move. The fact that the move was made will simply not be known by the other party unless the other party is willing to settle for a sum that is the same as or within an acceptable proximity to the offer the party would like to make or is willing to split the difference between pending offers, in which case no negotiating disadvantage results from making the move. Furthermore, if the two offers are not within that close proximity or if the other party does not signify a willingness to settle at a midpoint, then the party making a substantial change in its offer can effectively withdraw that offer because the other party will never know that the offer had been entered into the settlement system.

The present invention contemplates an automated settlement method and system that offers two different settlement processes. The two options can be called: (1) the Confidential Offer Program; and (2) the Split and Settle option. Under either option, one party, such as the party receiving money, initiates the automated settlement system for the specific dispute by opening an account on an internet website. That party must agree to a contract regarding this automated settlement process that is displayed on the secure website. This contract becomes binding upon acceptance of the same contract by the other party. When the account is opened, the initial party, or Offeror, enters an offer amount under either or both of the two settlement processes.

The website serves as a web shell for the underlying software that processes and maintains the requested account and administers the automated settlement process, including the automatic generation of e-mail notices to the parties. The settlement account is created by the first party to register, and the software automatically sends an e-mail notification to the other party that a settlement account has been opened and that an offer to settle the dispute has been made. The other party must then register on the website for the settlement process to commence. As mentioned above, this registration by the other party, or Offeree, requires acceptance of the automated settlement contract. The system can establish a predetermined time frame in which registration by the Offeree must be completed, for instance fifteen days from the e-mail notice. A second reminder notice can be sent, but a failure to register by the other party will result in the account being automatically closed. A failure to register can be taken as a signal that the other party is unwilling to participate in an automated settlement process; however, the initiating party can re-open the account if he/she believes that the failure to register was unintentional.

One of the settlement options that can be used is the Confidential Offer Program which provides a method for helping two parties negotiate an agreement as to how much money one party (the Payor) will pay to the other party (the Payee). The money payment can be related to any type of account, transaction or circumstance, such as a disputed debt, conflict over costs of goods or services or money damages for a sustained injury by the payee. The principal feature underlying the Confidential Offer Program is the ability of each party to tender any offer through a secure, confidential internet account. Neither party learns of the amount of the other party's offers unless and until the disclosure condition arises. When this disclosure condition is met, the latest offer of each party is disclosed to the other party. The contract executed by both parties will make the disclosed settlement offers binding upon both parties.

In accordance with the present invention, the disclosure condition for the Confidential Offer Program is determined according to a Proximity Test. In the preferred embodiment of the invention, the Proximity Test is initially applied to the Offeror's opening offer. In a first form, the Proximity Test determines whether the Offeree's responsive offer is within a specified dollar amount, or within a specified percentage, of the Offeror's opening offer. This dollar amount or percentage can be pre-selected by the party initiating the Confidential Offer Program (the Offeror).

By way of example, assume that the automated negotiations commence with the Offeror/Payee's (or plaintiff in a litigation context) initial demand of $100,000 and that the offeror sets the Proximity Test value at $20,000. If the responding party (the Offeree/Payor or defendant) makes an offer of $85,000, the disclosure condition is met at that amount because the offers are within the Proximity Test established by the Offeror. The same result can be obtained if the Proximity Test is a specified percentage. For instance, if the Proximity Test value is 70%, then disclosure condition will be reached if the responding party (Payor) offers an amount of $70,000 or more.

A second disclosure condition for the Confidential Offer Program can be established using the Payor's (or defendant's) offer, rather than the Offeree/plaintiff's demand as the offer to which the Proximity Test is applied. In this instance, the disclosure condition will be met when a proposed demand by the Payee/plaintiff is less than or equal to the defendant's initiating offer plus a specified dollar amount, or less than or equal to specified multiple of the defendant's proposed offer.

It should be understood that the Proximity Test from the Payor's point of view is the analog of the Payee's Proximity Test. Regardless of which is used, the Proximity Test provides a measure of how close the offers must be before the offers will be disclosed.

With any of the above Proximity Tests, once a responsive offer triggers the disclosure condition, the offers are disclosed. If the offers happen to be identical, settlement is reached and the negotiation is over. More often, however, the two offers will differ (although they are still within the Proximity Test applied by the automated settlement system). In accordance with the preferred embodiment of the invention, the binding offers are disclosed to both parties and the parties must then confer to decide how to deal with the difference. The parties could agree to split the difference (using the “split and settle” feature) or one party may agree to accept the binding offer made by the other party.

The objective of the automated settlement system in this case is to bring the parties together at a point where settlement appears virtually assured. In this case, the principal benefit of this system is that it relieves the parties of the fears associated with the negotiation process that were discussed above. The present system thus serves as a vehicle for the parties to have an impartial “virtual third party” accept and analyze the offer and counter-offer to determine whether settlement is a real possibility. Obviously, if a counter-offer is outside the Proximity Test relative to the initial offer, the parties are not in a meaningful settlement “mood”. The present system does not moralize or place blame, nor does it disclose confidential offers unless and until a meeting of the minds is signified (by the occurrence of a disclosure condition). At a minimum, the present system provides a mechanism for the parties to “test the water” by presenting their respective offers in a confidential way. If the disclosure conditions are not met (i.e., if the Proximity Test failed) then the parties know that they are far apart on their settlement positions.

On the other hand, if the disclosure condition is met, it is presumed in most cases that the parties will be able to complete the negotiations without any further help, or interference, from the automated settlement system. The “binding” nature of the respective offers means that one party can accept the other party's disclosed offer and that the other party cannot retract the offer or try to negotiate a different amount. For example, if the binding offers are $100,000 for the Payor and $105,000 for the Payee, the Payor can immediately accept the Payee's offer for a binding settlement. The Payee cannot decide that he/she should have asked for more money—the offer is binding according to the contract executed by both parties when the automated settlement process was initiated.

In accordance with the preferred embodiment of the invention, the process is terminated either when the responding offer is determined to fall outside the Proximity Test, or when the Proximity Test is met and the offers are disclosed to the parties. In the latter case, it is again presumed that in many cases the parties will be able to come to a final meeting of the minds, having already met the disclosure criteria that they established themselves. In the former case, the parties can go their separate ways or one of the parties can start a new settlement process. For instance, once a first automated negotiation process fails to produce a settlement or disclosure of offers, one party may decide to open a new negotiation through the present automated system, but with a new offer that is closer to what might be expected to be accepted by the other party.

In some respects this automated settlement system can be used to incrementally proceed to a final settlement. For instance, suppose in an initial negotiation a Payor offered $100,000 with a $50,000 disclosure range and the Payee's counter-offer was $150,000. The counter-offer met the Proximity Test since it was within $50,000 of the original offer, so the binding offers are disclosed. If neither party decides to accept the other party's binding offer, this first negotiation is terminated. The Payor may then decide to initiate a new negotiation with an initial offer of $120,000 and a disclosure range of $10,000. The Payee may decide to accept the renewed negotiation, execute the new binding contract and present a new counter-offer of $130,000. Again, the disclosure condition is met and the two “binding” offers are disclosed. Acceptance of either binding offer, or mutual agreement to “split and settle” at this point will lead to a successful conclusion to the automated settlement process.

Alternatively, in this second negotiation, the Payor may decide to propose the “split and settle” option based on the last known disclosed offers in the first negotiation—i.e., $100,000 and $150,000. If the Payee agrees, then the case is settled at the mid-point, or $125,000.

The use of the settlement system is expected to result in the settlement of disputes sooner than settlement might otherwise occur, thus saving trial preparation or other litigation costs. The dynamics of each dispute will determine the point at which this settlement system will help the parties reach settlement. In some cases, it could be at the very beginning of the negotiation process. In others, it might be near the end of the process.

The second approach available to potential negotiators through the present invention is the Split and Settle option. With this approach, one party proposes to split the difference between known settlement offers to produce a binding settlement at the midpoint. As indicated above, both parties have the opportunity to signify their willingness to split the difference, but settlement is not reached unless both parties agree to this option. If either party is unwilling to split the difference, the automated negotiations will still proceed under the Confidential Offer Program

Operation of the System

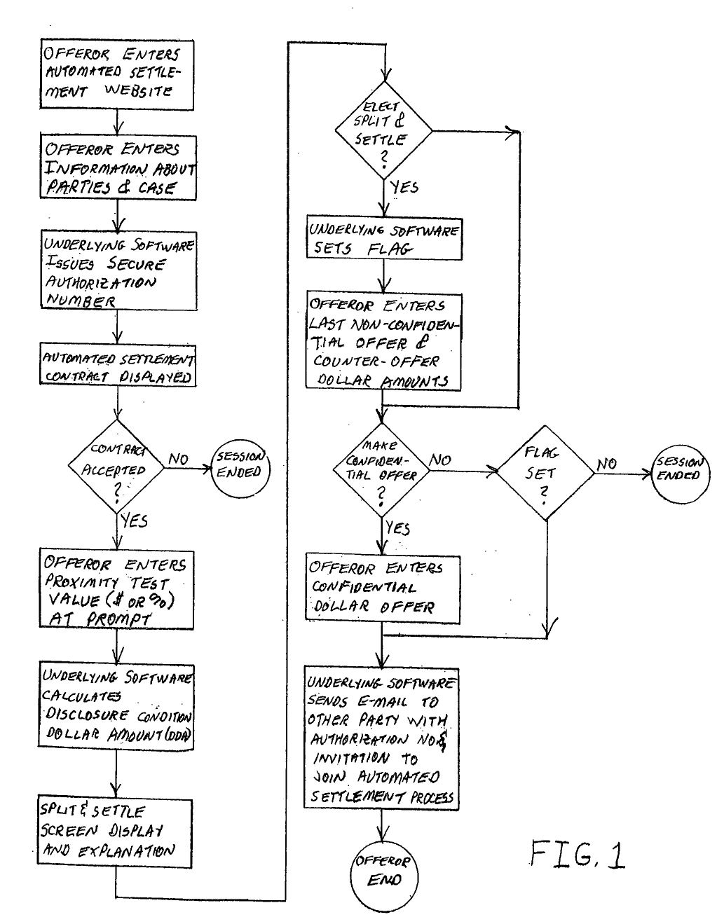

The flowchart in FIG. 1 illustrates the steps of the automated settlement method of the present invention from the Offeror's point of view. As explained above, the Offeror is simply the first party to a dispute that decides to avail him/herself of the automated settlement method. The offeror can be a Payee, meaning a party expecting to receive a dollar amount in settlement, or a Payor, meaning a party expecting to pay some dollar amount.

In accordance with the present invention, the Offeror initiates the process by entering the secure automated settlement website. The home screen of the website can display an explanation of the process and the automated settlement process options. The Offeror can elect to commence the process or simply leave the home page. To initiate the automated settlement process, the Offeror first enters information about the parties and the case. At a minimum the information must include the names and e-mail addresses of the parties. Ideally, the Offeror will include information specific to the particular dispute, such as a unique identifier or case name. The dispute-specific information must be descriptive enough so that the other party can readily identify the particular dispute. This information is important where one or both of the parties are involved in several mutual negotiations, such as might arise between insurance companies. The information can also include an identification of authorized negotiators for the Offeror. This identification is helpful where several negotiators serve a single client, such as where the client is an insurance company.

When sufficient information has been entered by the Offeror, the underlying program issues a unique secure authorization number that will be used by the parties to track the automated settlement process. The automated settlement contract is then displayed to be read by the Offeror. The contract may suitably be executed online at the settlement system website. By executing this contract each party is agreeing to consummate the settlement under the agreed conditions, whether the parties proceed to settlement by way of the Confidential Offer process or the Split and Settle process. If the Offeror refuses to execute the contract, the session is terminated and the other party has no knowledge of the Offeror's aborted activities.

Next, in one embodiment, the offeror must select the dollar amount or percentage to be used as the Proximity Test. That amount or percentage is included in the e-mail sent to the other party, along with the other case-specific information. The Proximity Test value entered at this stage in the automated process is essentially independent of any confidential offer amount the Offeror would make. For instance, a Proximity Test value of $25,000 signifies the Offeror's willingness to have mutual offers disclosed if they are separated by $25,000 or less, whatever those offers happen to be.

The website then proceeds to various screens to guide the Offeror through the offer process. The first screen asks the Offeror whether he/she wants to use the Split and Settle Option. If the Offeror selects this option, he/she is prompted to enter the amounts of the two offers being split. These two amounts are the non-confidential products of previous negotiations, meaning that these numbers have been previously exchanged by the parties prior to the initiation of this automated settlement process. In a specific example, it can be supposed that the parties had engaged in verbal negotiations that ended with the Offeror demanding $150,000 and the Offeree proposing to pay $100,000. When the negotiations stalled, the Offeror decided to initiate the present automated settlement system. When the Split and Settle screen appears, the Offeror enters these two dollar amounts and accepts the Split and Settle option.

Whether or not the Offeror elects the Split and Settle Option, the next web page screen directs the Offeror to enter a confidential cash settlement amount. The Offeror can decline to make such an offer, and instead rely only upon a previous election to utilize the Split and Settle option. Alternatively, or in conjunction with a Split and Settle selection, the Offeror can enter a dollar amount at which he/she would like to settle the dispute. The underlying software then calculates the disclosure dollar amount by applying the Proximity Test to the confidential settlement amount entered by the Offeror. This disclosure dollar amount is maintained in confidence, along with the confidential offer of the Offeror.

At this point the Offeror's work is done. The underlying program automatically calculates the disclosure condition dollar amount and stores this data with the secure authorization number. It is important to note that the website and the stored information will be secure. Nobody will be able to retrieve any information through the website; the website is only used to input information. Nobody except the system administrator can have access to the analysis software underlying the website that evaluates the competing offers relative to the triggering effects of the Proximity Test. For that matter, even the system administrator may be prevented access to the information associated with a secure authorization number. In an important aspect of the invention, all communication regarding the progress of the automated settlement will occur by e-mail. The e-mail itself can be encoded to ensure that only an authorized person will have access to the information.

If the Offeror has made at least one offer (i.e., Split and Settle and/or confidential dollar amount), the underlying program sends an e-mail to the identified other party (the Offeree). This e-mail will explain that the web-based automated settlement process has been initiated by the Offeror, will inform the Offeree that an initial settlement offer has been made, and provide the secure authorization number to the Offeree.

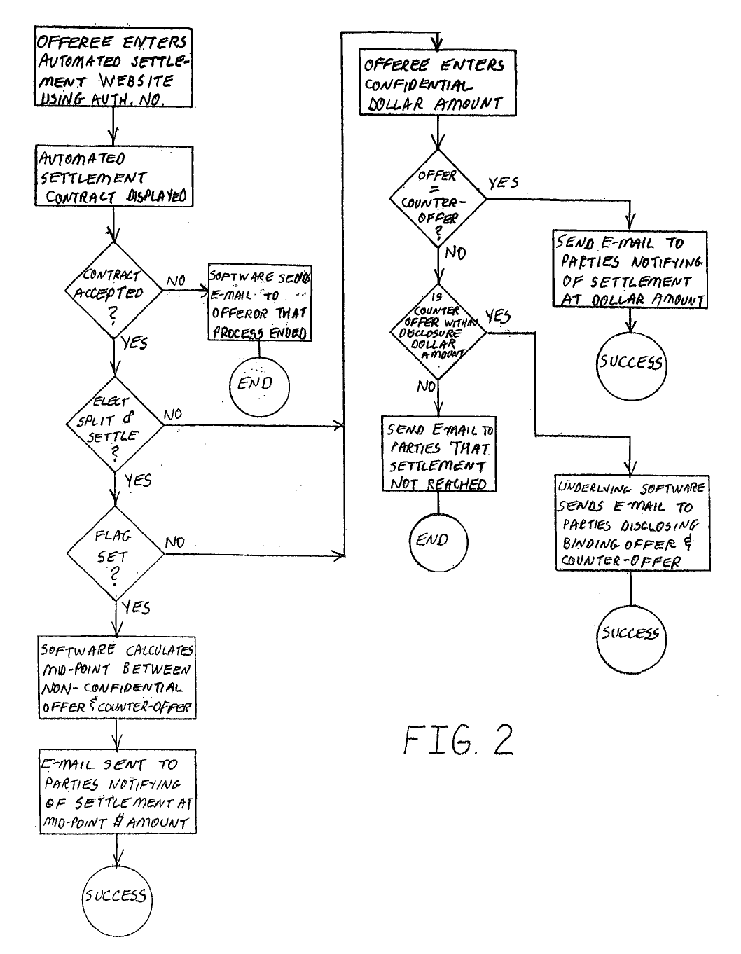

The flow of activity involving the Offeree in accordance with one embodiment of the invention is shown in the flowchart of FIG. 2. Naturally, if the Offeree is not interested in trying to effect an automated settlement, he/she does not need to take any action. However, if this approach is acceptable, the Offeree enters the automated settlement website. The pages of the website will explain the process and display the automated settlement contract. The Offeree can refuse to execute the contract and cause the underlying program to send an e-mail to the Offeror that the Offeree ended the process.

If the Offeree executes the contract, the website prompts the Offeree to enter a confidential counter-offer. As explained above, the Offeree has no knowledge of the original offer made by the Offeror to initiate the process. In this respect, the counter-offer is made “in the dark”, although it is likely that both parties have some idea what the other party expects in settlement.

The first web page screen asks the Offeree if he/she wants to use the Split and Settle Option. The screen displays the previous non-confidential dollar amounts that had been entered by the Offeror when the process was initiated. In the specific example, these amounts were $150,000 and $100,000. The Offeree can obviously calculate the mid-point between these two amounts ($125,000) and immediately decide whether this amount is acceptable. If it is, then the Offeree answers yes to the Split and Settle Option. If the originating party, or Offeror, had also answered yes to this option, a settlement is automatically reached at the mid-point. An e-mail is sent to both parties indicating that settlement has been reached at the specific mid-point dollar amount ($125,000).

If settlement is not reached at the Split and Settle screen, the web site proceeds to the next screen at which the Offeree enters a confidential settlement dollar amount. Again, the Offeree has no knowledge of the Offeror's activity, other than that the Offeror requested the automated settlement. If the two confidential offer amounts are identical, then settlement is obvious and the system sends an e-mail to both parties informing them that a binding settlement has occurred at the particular dollar amount.

If the counter-offer does not match the original offer, the underlying program compares the counter-offer to the disclosure dollar amount (DDA). If the disclosure condition is not met (i.e., the counter-offer is outside the DDA), then an e-mail is sent to both parties that the process has ended without resolution.

On the other hand, if the disclosure condition is met (i.e., the counter-offer falls between the DDA and the original offer), then the underlying program sends an e-mail to both parties disclosing the binding offer and counter-offer dollar amounts. At this point the program ends and final settlement is in the hands of the parties, as outlined above.

In accordance with one embodiment of the invention, there is no limitation on the number of offers that can be exchanged between the parties. Since participation in the automated on-line settlement system is voluntary, the parties can agree to terminate the negotiations if there is no apparent progress toward a resolution. The only limitations imposed in this scenario are time limits on providing responses. If a party unilaterally wishes to end the negotiations, he/she need not reply to an outstanding offer—an event that will automatically terminate the on-line process.

The settlement system has the potential to provide an excellent return on the investment made (i.e., the fee paid to register with the system) for use of the service. If a dispute settles early, the savings of litigation expenses realized might literally be hundreds of times the cost of using the service. In those cases in which a defendant can add some extra dollars in order to avoid the litigation costs, and a plaintiff is willing to settle quickly for a reasonable sum rather than litigate for an extended period of time, the settlement system enables the parties to make those early exploratory settlement offers without actually “putting them on the table” for the other side to see. Without the settlement system, those settlement opportunities may largely go unexplored because neither side is willing to throw out a number that they may want to take back later.

Even in those cases at the other extreme, in which both sides want to huff and puff (and frequently bluff!) about the strengths of their cases. and about how anxious they are to get to trial, there does eventually come a time when settlement talks get serious. The present inventive settlement system will have the same usefulness at that point in the process as it does in any other case. It obviously cannot save as many dollars as were potentially savable earlier in the case, but a more efficient settlement will still produce savings for both sides.

The settlement system offers another specific cost-saving opportunity immediately prior to mediation. Prior to spending thousands of dollars (and lots of time) on mediation, the parties can “give it their best shot” through the settlement system at getting closer together on a settlement number. If they are able to “self-mediate” on a confidential basis, the potential of saving thousands of dollars in mediation-related expenses can become a reality.

Use of the settlement system adds a whole new dimension to settlement negotiations. Skilled negotiators will have an additional tool to use in getting to a settlement number. Valuable information will be available to both parties as to their opponent's “bottom line” at any point in the negotiation process. There are no prescribed methods or limitations on how to use the settlement system. It is simply an available tool, and those involved in the negotiation process will no doubt discover many ways to use it to their advantage.

It will be appreciated that the above described embodiments are merely exemplary, and that those of ordinary skill in the art may readily devise their own implementations that incorporate the principles of the present invention and fall within the spirit and scope thereof.

1. A method for automated settlement of a monetary dispute comprising the steps of:
registering a dispute on a web-based automated settlement system, including entering information concerning the parties and the dispute, and entering communication addresses of the parties;
generating a secure authorization number unique to the particular dispute and communicating that number to the parties via their respective communication addresses.
storing the information concerning the parties and the dispute in a data storage location associated with the secure authorization number;
displaying a settlement contract obligating the parties to the disclosure of binding offers or binding settlement at a particular dollar amount upon the occurrence of pre-determined negotiation conditions;
terminating the automated settlement process if one of the parties declines to execute the settlement contract;
displaying a split and settle option to a first party in which the monetary settlement is reached at the mid-point dollar amount between non-confidential offers of the parties prior to registering the dispute on the web-based automated settlement system;
signifying election of the split and settle option by a first party including entry of the non-confidential offers of the parties;
storing the non-confidential offers in the data storage location associated with the secure authorization number;
notifying the second party of the registration of the dispute on the web-based automated settlement system and of the secure authorization number;
upon the second party accessing the web-based settlement system using the secure authorization number, displaying the split and settle option to the second party together with the non-confidential offers; and
notifying the parties that settlement has been reached at the mid-point dollar amount if the second party signifies election of the split and settle option.

2. The method for automated settlement of a monetary dispute of claim 1, wherein the communication addresses are e-mail addresses of the parties and the notifying steps of the method include sending an e-mail message.

3. The method for automated settlement of a monetary dispute of claim 1, further comprising:
entering a proximity test value by a first party, the proximity test value indicative of a negotiation condition relative to a dollar amount offer of the first party;
entering a dollar amount offer by the first party and storing such dollar amount offer in the memory associated with the secure authorization number;
calculating a disclosure dollar amount by applying the proximity test value to the dollar amount offer;
upon a second party accessing the web-based settlement system using the secure authorization number, displaying a request to enter a counter-offer, while maintaining the offer of the first party confidential;
upon entry of a counter-offer dollar amount by the second party, comparing the counter-offer dollar amount to the disclosure dollar amount; and
if the counter-offer dollar amount is not within the disclosure dollar amount, terminating the settlement process while maintaining the offer and counter-offer confidential;
otherwise, if the counter-offer dollar amount is within the disclosure dollar amount, notifying the parties of the offer and counter-offer dollar amounts;
wherein the settlement contract makes the offer and counter-offer binding on the respective party so that settlement is reached if one party accepts the other party's offer dollar amount.

4. A method for automated settlement of a monetary dispute comprising the steps of:
registering a dispute on a web-based automated settlement system, including entering information concerning the parties and the dispute, and entering communication addresses of the parties;
generating a secure authorization number unique to the particular dispute and communicating that number to the parties via their respective communication addresses.
storing the information concerning the parties and the dispute in a data storage location associated with the secure authorization number;
displaying a settlement contract obligating the parties to the disclosure of binding offers upon the occurrence of pre-determined negotiation conditions;
terminating the automated settlement process if one of the parties declines to execute the settlement contract;
entering a proximity test value by a first party, the proximity test value indicative of a negotiation condition relative to a dollar amount offer of the first party;
entering a dollar amount offer by the first party and storing such dollar amount offer in the memory associated with the secure authorization number;
calculating a disclosure dollar amount by applying the proximity test value to the dollar amount offer;
notifying a second party of the registration of the dispute on the web-based automated settlement system and of the secure authorization number;
upon a second party accessing the web-based settlement system using the secure authorization number, displaying a request to enter a counter-offer, while maintaining the offer of the first party confidential;
upon entry of a counter-offer dollar amount by the second party, comparing the counter-offer dollar amount to the disclosure dollar amount; and
if the counter-offer dollar amount is not within the disclosure dollar amount, terminating the settlement process while maintaining the offer and counter-offer confidential;
otherwise, if the counter-offer dollar amount is within the disclosure dollar amount, notifying the parties of the offer and counter-offer dollar amounts;
wherein the settlement contract makes the offer and counter-offer binding on the respective party so that settlement is reached if one party accepts the other party's offer dollar amount.

5. The method for automated settlement of a monetary dispute of claim 4, wherein the communication addresses are e-mail addresses of the parties and the notifying steps of the method include sending an e-mail message.
